(19) United States
(12) Patent Application Publication
(10) Pub. No.: US 2013/0327471 A1
(43) Pub. Date: Dec. 12, 2013

(54) METHODS OF MAKING EMBOSSED LINER PANELS

(71) Applicant: Great Dane Limited Partnership, Chicago, IL (US)

(72) Inventors: Charles W. Hedley, Danville, IN (US); Cory Richard Lookebill, Knightsville, IN (US)

(73) Assignee: Great Dane Limited Partnership, Chicago, IL (US)

(21) Appl. No.: 13/967,470

(22) Filed: Aug. 15, 2013

Related U.S. Application Data
(63) Continuation of application No. 12/193,446, filed on Aug. 18, 2008.

(51) Int. Cl. B32B 38/06; B32B 38/10

(52) U.S. Cl. CPC B32B 38/06; B32B 38/10
USPC 156/219

(57) ABSTRACT

A method of making an embossed liner panel for use as an interior liner of a cargo carrying vehicle is provided. A reinforced thermoplastic polymer feedstock, an impression mat having a textured surface, and a release film are provided. The materials are stacked such that the film is provided between the feedstock and the mat. The stacked materials are fed into a laminator and a roller therein moves the stacked materials therethrough. The laminator heats and compresses the materials to emboss the textured surface of the mat onto the feedstock to form the embossed liner panel. Thereafter, the mat is released from the feedstock and collected for reuse. The mat is a separate component from the roller of the laminator.

### CLAIM OF PRIORITY

This application is a continuation of U.S. patent application Ser. No. 12/193,446 filed Aug. 18, 2008, the entire disclosure which is incorporated herein.

### FIELD

The present disclosure relates to composite liner panels and more particularly to methods of making embossed composite liner panels for use with cargo carrying vehicles such as trucks, trailers including dry freight and insulated or refrigerated trailers, cargo containers, and railcars, as well as agricultural and industrial applications.

### BACKGROUND

Thermoset composite liners used in cargo carrying vehicle walls typically have a glossy, textured surface. Due to the nature of thermoset processing, this texture is relatively easy to produce during the manufacture of the lining. The texture is largely decorative, but the texture also distracts a viewer from noticing damage or other imperfections in the surface of the textured material. The relatively low cost of thermoset materials have made them a popular choice in cargo carrying vehicle walls and the textured look of thermoset materials may be considered a standard finish in these cargo carrying vehicles. While thermoset materials work reasonably well, thermosets may lack substantial impact and puncture resistance. Thermosets may be prone to damage during loading and/or shifting freight. As should be well understood, “thermoset” refers to a class of polymers that, when cured using heat, chemical or other means, change into a substantially infusible and insoluble material. Once cured, a thermoset material will not soften, flow, or distort appreciably when subjected to heat and/or pressure.

Recently, thermoplastic composite wall liners have gained a prominent position in the marketplace due to their improved toughness versus thermoset liners. Thermoplastic composite wall liners are well suited to the rigors of freight hauling. The smooth surface of thermoplastic composite wall liners is a feature which distinguishes them from thermoset liners and results from the processes used to produce the thermoplastic composite wall liners. As should be well understood, “thermoplastic,” refers to a class of polymers that can be repeatedly softened by heating and hardened by cooling through a temperature range characteristic of the particular polymer and that in the softened state can be shaped.

Some processes used to make thermoplastic composite materials utilize essentially continuous layers of fiber reinforced polymer fed into continuous double belt lamination equipment. The layers enter the heating zone and are heated to the melting point of the polymer. The belts provide consolidation pressure, thereby filling the interstitial spaces of the reinforcement. The material then enters the cooling zone where the polymer solidifies, producing a sheet of uniform thickness and composition. Typically a smooth surface is placed against the molten polymer, thus imparting a glossy and smooth surface to the polymer.

### SUMMARY

The present disclosure includes a method of making an embossed liner panel for use as an interior liner of a cargo carrying vehicle, the method comprising the steps of providing a reinforced thermoplastic polymer feedstock and an impression mat, wherein the impression mat includes a textured surface, stacking the reinforced thermoplastic polymer feedstock, and the impression mat, and heating and compressing the reinforced polymer feedstock and the impression mat to impart the textured surface to a thermoplastic composite liner panel.

The present disclosure also includes a method of making an embossed liner panel for use as an interior liner of a cargo carrying vehicle, the method comprising the steps of providing a first reinforced polymer feedstock, a second reinforced polymer feedstock, and a first impressing surface and a second impressing surface, and stacking and heating the first and second reinforced polymer feedstocks to impart textured surfaces to a first thermoplastic composite liner panel and a second thermoplastic composite liner panel.

The present disclosure also includes a cargo carrying vehicle including an interior liner panel, the cargo carrying vehicle comprising a container including walls, a floor and a roof, wherein at least one of the walls, floor and roof include a thermoplastic interior liner panel, wherein the thermoplastic interior liner panel defines a textured interior surface.

### BRIEF DESCRIPTION OF THE DRAWINGS

A full and enabling disclosure of the present disclosure, including the best mode thereof, directed to one of ordinary skill in the art, is set forth in the specification, which makes reference to the appended drawings, in which:

FIG. 1 is a side elevation view of a cargo carrying vehicle and chassis that may be attached to a tractor for transport over a highway;

FIGS. 1A and 1B are respective rear and front elevation views of the container and chassis of FIG. 1;

FIG. 1 C is a perspective view of a trailer that may be attached to a tractor for transport over a highway;

FIG. 2 is a schematic illustration of an apparatus for forming a liner panel in accordance with an embodiment of the present disclosure;

FIG. 3 is a schematic illustration of a liner panel m accordance with an embodiment of the present disclosure;

FIG. 4 is schematic illustration of an impression material in accordance with an embodiment of the present disclosure;

FIG. 5 is a schematic illustration of an apparatus for forming a liner panel in accordance with an embodiment of the present disclosure;

FIG. 6 is a schematic illustration of an apparatus for forming a liner panel in accordance with an embodiment of the present disclosure;

FIG. 7 is a schematic illustration of an apparatus for forming a liner panel in accordance with an embodiment of the present disclosure; and

FIG. 8 is a schematic illustration of a liner panel m accordance with an embodiment of the present disclosure.

Repeat use of reference characters in the present specification and drawings is intended to represent same or analogous features or elements of the disclosure.

### DETAILED DESCRIPTION

Reference will now be made in detail to presently preferred embodiments of the disclosure, one or more examples of which are illustrated in the accompanying drawings. Each example is provided by way of explanation of the disclosure, not limitation of the disclosure. In fact, it will be apparent to those skilled in the art that modifications and variations can be made in the present disclosure without departing from the scope and spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

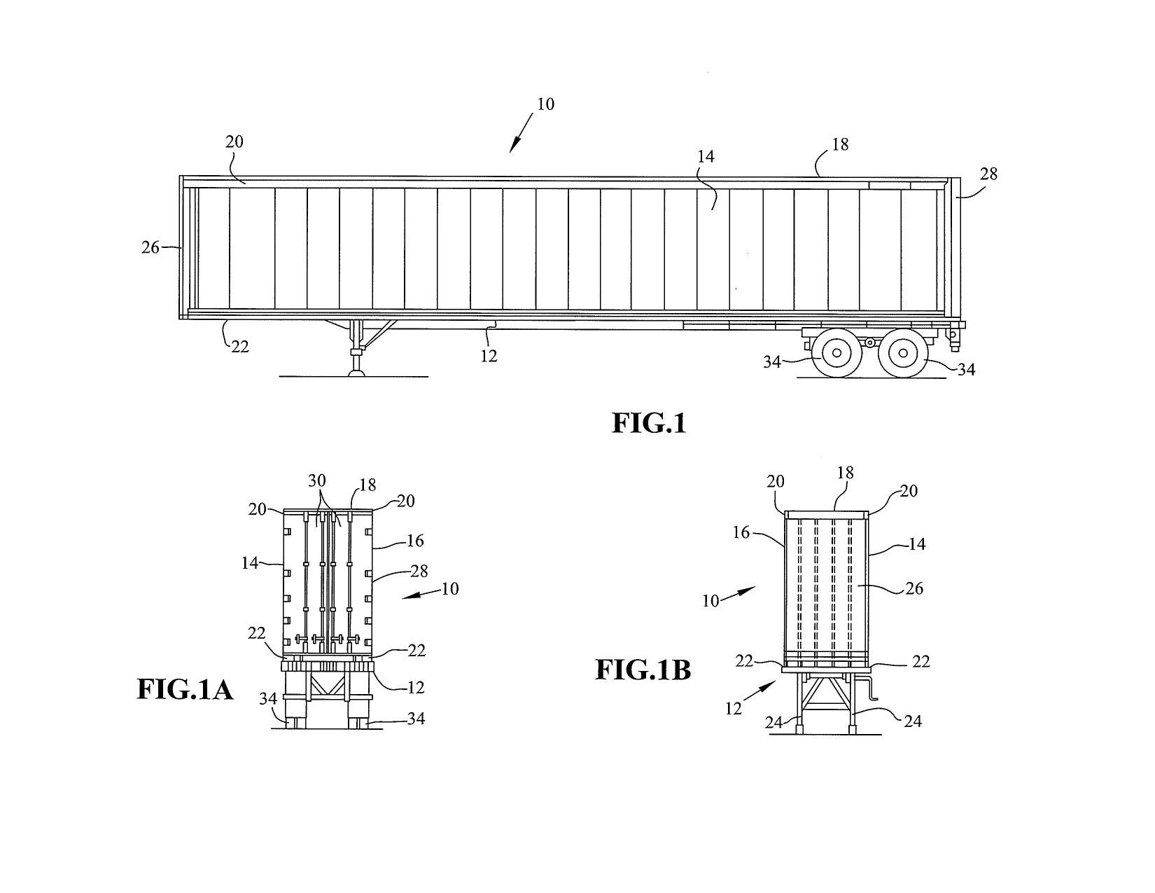

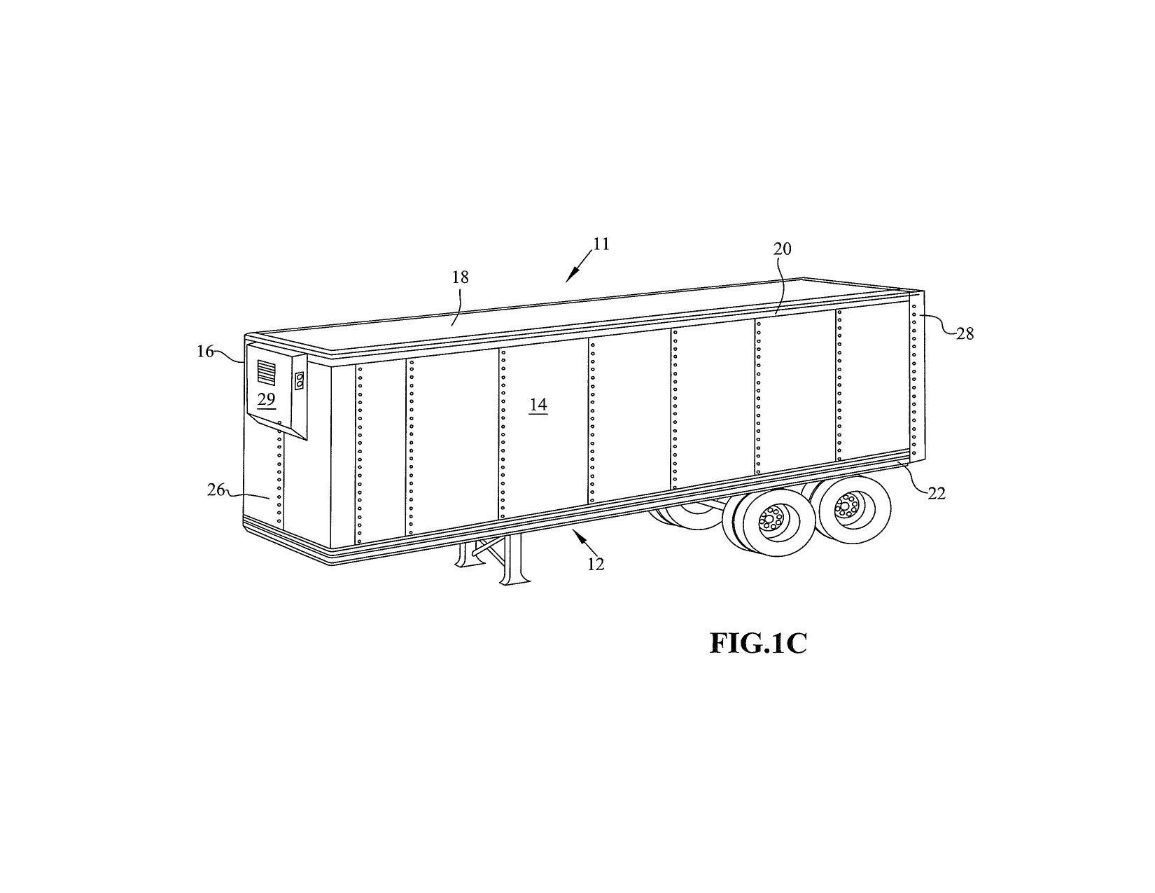

FIGS. 1, 1A and 1B illustrate a cargo container 10 having a floor 12, two side walls 14 and 16 and a roof 18. Each side wall is identically constructed. Two top rails 20 attach roof 18 to side walls 14 and 16, respectively, and two bottom rails 22 connect floor 12 to side walls 14 and 16. Once assembled, roof 18, floor 12 and side walls 14 and 16 form container 10 having a generally rectangular cross-section when viewed from the rear (FIG. 1A). The distance between opposing inner surfaces of side walls 14 and 16 is generally greater than ninety inches, and the distance between outer surfaces of opposing side walls 14 and 16 is generally less than 110 inches.

Container 10 includes a forward end wall 26 and a rearward end frame 28. Two doors 30 at the container's rearward end are pivotally connected to rear end frame 28. Container 10 rests on a chassis formed by one or more longitudinal beams extending between retractable legs 24 and a plurality of ax led wheels 34. Wheels 34 support the container's rearward end, and facilitate the container's movement, when container 10, supported by the chassis, is coupled to a tractor (not shown). Cargo container 10 defines an interior cargo compartment defined by assembled side walls 14 and 16, forward wall 26, rear doors 30 and roof 18.

FIG. 1C illustrates van type trailer 11 having floor 12, two side walls 14 and 16 and roof 18. Each side wall is identically constructed. Two top rails 20 attach roof 18 to side walls 14 and 16, respectively, and two bottom rails 22 connect floor 12 and the trailer's deck structure to side walls 14 and 16. Trailer 11 includes forward wall 26 and rearward end frame 28. Two doors (not shown) at the trailer's rearward end are pivotally connected to rear end frame 28, although it should be understood that a roll-type door may also be used. As with container 10 (FIG. 1), assembled trailer 11 defines an interior cargo compartment defined by assembled side walls 14 and 16, forward wall 26, rear doors 30 and roof 18. The distance between opposing inner surfaces of side walls 14 and 16 is generally greater than ninety inches, and the distance between outer surfaces of opposing side walls 14 and 16 is generally less than 110 inches. An optional refrigeration unit 29 mounted in forward wall 26 outputs conditioned air to the interior cargo compartment. The terms “side wall,” front wall” and “rear door” are used separately in the present discussion for purposes of explanation, and it should be understood that the term “side wall,” as used herein, may refer to any side wall 14 and 16, front wall 26 or rear doors 30 of an insulated or other structure. The term “wall” should be understood to include “side wall” as well as roof 18.

The difference between container 10 and trailer 11 is that trailer 11 has an integral chassis and suspension, and does not have frames that are configured to permit the lifting and stacking of container 10, as should be understood in this art. In other words, as should be well understood in this art, container 10 is a box that is placed on and removably attached to the longitudinal I-beam type chassis, as shown in FIG. 1.

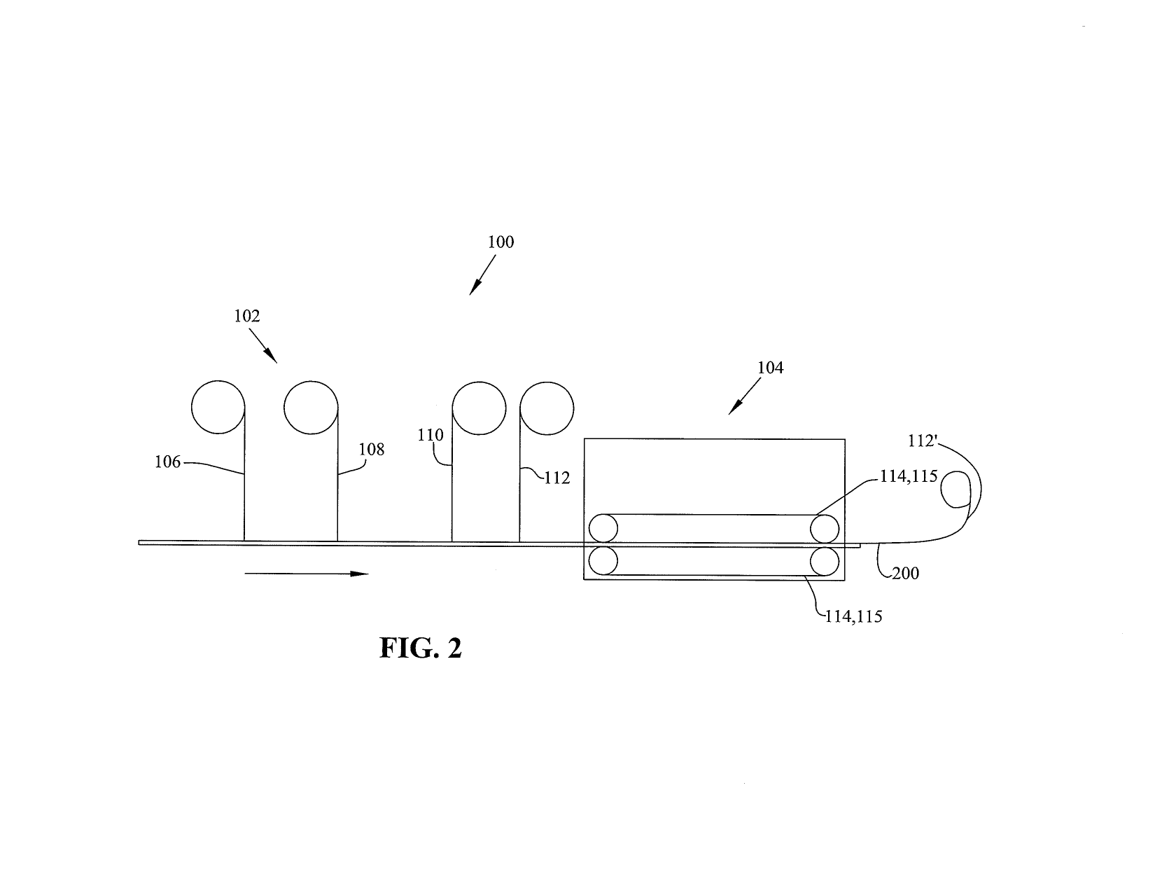

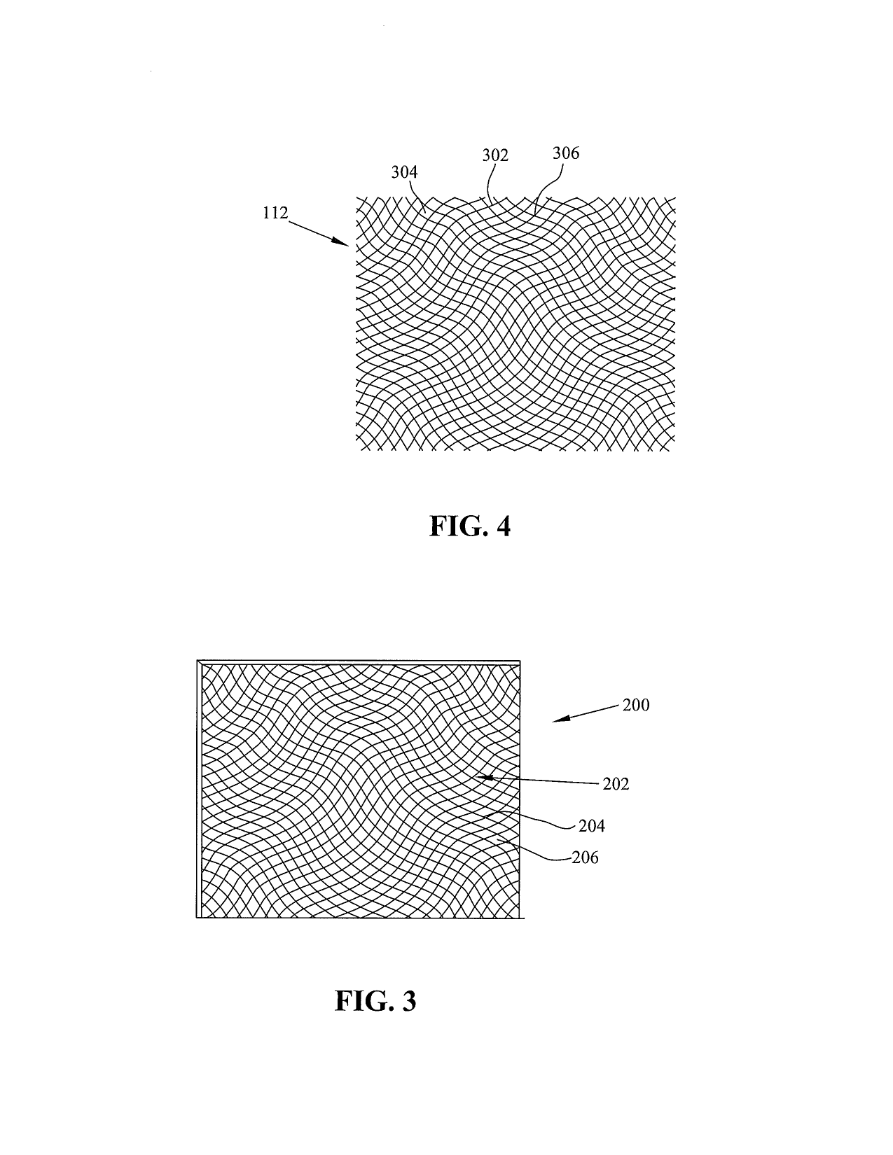

FIG. 2 schematically illustrates a layout 100 for forming an composite liner panel 200 which may be used as an interior liner, an outside skin of a wall panel, or a portion of the side wall in accordance with an embodiment of the present disclosure. In another embodiment, composite liner panel 200 may be used as an outside liner or outer skin on a wall panel including roof 18 (FIG. 1 C). Layout 100 provides an interior laminate liner to achieve a desired textured surface 202 (FIG. 3) for thermal plastic composite wall liner 200. Layout 100 may illustrate a consolidation machine or a portion of a consolidation machine. One suitable consolidation machine 100 is a contact heat oven manufactured and sold by Schott & Meissner GmbH of Germany, and is known as the THERMOFIX® HP Double Belt Press. FIG. 2 should be understood to be a representative schematic example provided for illustrative purposes and that other consolidation machines may be used to form the laminate of the present disclosure. Furthermore, layout 100 may be incorporated within other consolidation processes, such as consolidation between heated rollers with or without a belt or in a heated fixed press. Rack 102 of layout 100 holds multiple rolls of material that are fed into laminator 104. Each roll of material is coplaner with the adjacent upper or lower rolls of material and is generally of the same length and width so that the resulting stacked or laminated material has uniform properties throughout. The material to form the thermoplastic composite liner panel 200 are stored on large rolls on rack 102.

FIG. 2 illustrates four materials being fed co-planer into layout 100. Reinforced polymer feedstock 106, polypropylene (PP) color layer 108, polyethylene terephthalate (PET) release film 110, and impression mat 112. Reinforced polymer feedstock 106 may be formed of a glass reinforced polypropylene. One suitable reinforced polymer feedstock 106 is a glass and polypropylene composite fabric manufactured and sold by Owens Corning of Toledo, Ohio, and is known as TWINTEX®. Other suitable reinforced polymer feedstocks 106 are glass and polypropylene composite laminates manufactured and sold by Polystrand of Montrose, Colo., and are known as TRI-PLY®, X-PLY®, and QUAD-PLY®. Another suitable reinforced polymer feedstock 106 is a glass and polypropylene composite laminate manufactured and sold by Crane Composites of Channahon, Ill., and is known as ZENICON®. Another suitable reinforced polymer feedstock 106 is a glass and polypropylene composite laminate manufactured and sold by US Liner of Cranberry Township, Pennsylvania, and is known as VERSITEX®.

Polypropylene has a melting temperature of 173° C. Glass reinforced polypropylene may have a melting temperature, which causes the polypropylene to separate into parts, anywhere within the range of approximately 329° Fahrenheit (approximately 165° Celsius) to approximately 343° Fahrenheit (approximately 173° Celsius). The melting temperature may vary with several factors such as pressure. Glass reinforced polypropylene may be formed from multiple strands of commingled glass fibers and polymer resin. Two types of materials; glass fibers and thermoplastic resin, may be intermingled to provide an even distribution of the two materials. Other types of fibers that may be used in reinforced polymer feedstock 106 may include aramid fibers, such as Kevlar™, carbon fiber, or natural fibers. Glass fibers can be continuous, discontinuous, chopped, woven, oriented, or random. Thermoplastics take several forms such as olefins, polyolefins, urethanes; polyethylenes such as polyethylene terephthalate, and polyamides such as nylons. A polypropylene resin is a solid polymeric material that exhibits a tendency to flow when subjected to heat and pressure, usually has a softening or melting range, and is frequently used to bind together reinforcement fibers such as glass fibers. The added fibers are used to provide structural reinforcement, such as strength and toughness, to the thermoplastic composite liner panel. Other reinforcement materials can be used with composite liner panel such as particulates, aggregates, and metal reinforcements such as wires, rods, or cables.

Polypropylene color layer 108 is optional. Color layer 108 provides a uniform color to finished thermoplastic composite liner panel 200. One suitable color layer 108 is a polypropylene and polyester scrim film manufactured and sold by Xamax Industries of Seymour, Conn., and is known as FLOLAM®. Another suitable color layer 108 is a polypropylene film manufactured and sold by Xamax Industries of Seymour, Conn., and is known as FLOCORE®. Color layer 108 may be particular to the polymer feedstock.

Polyethylene terephthalate release film 110 may provide a release surface between impression mat 112 and reinforced polymer feedstock 106 or PP color layer 108. PET release film 110 may be metalized, colored, or contain printing. One suitable release film 110 is a metalized PET film manufactured and sold by Toray Plastics of America of North Kingston, R.I., and is known as MB-30. Another suitable release film 110 is a PET film manufactured and sold by Toray Plastics of America of North Kingston, R.I., and is known as F-65. PET comes in several forms and one of ordinary skill in the art would be able to make PET release film. In one embodiment, PET release film 110 is formed from a thin layer of polyester thermoplastic material. A polyester thermoplastic material is manufactured and sold by DuPont Teijin Films of Hopewell, Va., and is known as MELINEX®.

Impression mat 112 provides a textured surface for thermoplastic composite liner panel 200 Impression may be defined as to press into or onto something or to apply with pressure so as to leave a mark. A mat may be defined as a woven or tangled mass. The mass may take on various forms such as netting, mesh, interconnected units, and irregularly shaped parts. Impression mat 112 may include fibers Impression mat 112 may not be a mat at all but may include any material with an irregular surface. In an exemplary embodiment, impression mat 112 is a lightweight material. The material weight can be measured by aerial density, defined as the weight of material per area, such as pounds per square foot. In another exemplary embodiment, impression mat 112 is a low cost material. In yet another exemplary embodiment, impression mat 112 is a material which typically functions as a mat but may be modified to raise or lower the material density or to modify the material surface.

As previously discussed, textured impression mat 112 is optionally stacked or layered behind release film 110, i.e. thermoplastic composite liner panel 200 is on one side of release film 110 and textured impression mat 112 is on the opposite side of release film 110. Mat 112 imparts a textured surface onto liner 200. Suitable impression mats are ENKA Fusion® 7001 and ENKA Fusion® 7005, which are two-dimensional Nylon 6 matting distributed by Colbond Incorporated of Enka, N.C. ENKA Fusion® 7001 states a melting point of 420° F. Impression mat 112 is configured to impart a textured surface 202 (FIG. 3) onto thermoplastic composite liner panel 200.

In one embodiment, impression mat 112 is coplaner with the other adjacent materials and is generally of the same length and width so that the resultant composite thermoplastic liner panel 200 has uniform properties throughout. Each layer is approximately the same width and length as the other layers so that the resultant thermoplastic composite laminate is uniform from end to end. Layout 100 is able to form a continuous sheet of varying width and length of thermoplastic composite liner panel 200.

Impression mat 112 may cover less than the full surface of liner 200. One of ordinary skill in the art can envision embossing along only one edge or in a multitude of configurations. In another embodiment, impression mat 112 may be configured to not emboss a top portion, a bottom portion or a surface left purposely flat for subsequent mounting or bonding purposes, or simply for appearance purposes, such as a middle portion, of liner 200.

Impression mat 112 may be made of fiber, such as natural fiber, metal, polymers, such as nylon, or other similar materials. The liner panel may be cut into desired sizes to be used in the interior liner walls which mayor may not be used in conjunction with cargo carrying vehicles such as buildings. Laminate may also be used in conjunction with other composite liner panels.

Thermoplastic composite liner panel 200 (FIG. 3) is formed by the following operation. The materials are stacked or layered and passed through laminator 104. Laminator 104 includes heating elements (not shown) which cause the thermoplastic materials to flow or pass through their melting point or glass transition temperature (for crystalline polymers). The temperature of heating in laminator 104 may be computer controlled to cause materials to flow but not liquefy. The control of the heating elements should be well understood and is therefore not discussed in detail herein. The flow is described as where thermoplastic materials reach a semi-liquid state.

In one embodiment, flow does not include a temperature and pressure to cause impression mat 112 to reach a semi-liquid state. In another embodiment, flow includes a temperature and pressure to cause reinforced polymer feedstock 106 to reach a semi-liquid state. In yet another embodiment, materials may be heated to include a range of potential temperatures, such as between approximately 350 degrees Fahrenheit (approximately 177° Celsius) to approximately 400 degrees Fahrenheit (approximately 204° Celsius). In still yet another embodiment, materials may be heated to a temperature of about 392 degrees Fahrenheit (approximately 200° Celsius). In still yet another embodiment, flow includes a temperature and pressure to cause impression mat 112 to impart a textured surface onto thermoplastic composite liner panel 200 (FIG. 3). As should be understood in this art, the ideal temperature varies depending upon the machine speed, the number of layers being consolidated and the flow characteristics of each material involved.

Laminator 104 also includes belt rollers 114 and calender rollers 115. Calendering means to press or squeeze materials, such as layered materials. Belt rollers 114 and calender rollers 115 of laminator 104 may apply sufficient pressure to the materials so that the materials form a generally uniform thermoplastic composite liner panel 200. The amount of pressure depends on the temperature of the input materials specified or the desired depth of embossing or impression, the desired run speed of the layered material, and the desired thickness of the output composite liner panel.

Belt rollers 114 and calender rollers 115 are also capable of running at various run speeds including between the range of approximately one meter per minute to approximately seven meters per minute. In one embodiment, belt rollers 114 and calender rollers 115 are run at approximately six meters per minute.

Furthermore, belt rollers 114 and calender rollers 115 are capable of taking into consideration variations in total material thickness, based on several factors such as inclusion of or removal of a layer of impression mat 112. Belt rollers 114 and calender rollers 115 are also capable of running at various gaps including between the range of approximately 0.8 millimeters to approximately 5 millimeters. In one embodiment, belt rollers 114 and calender rollers 115 are run at approximately 1.26 millimeter gap.

As is understood by one of ordinary skill in the art, calender rollers 115 act as the main gap setting mechanisms. As shown in FIG. 2, belt roller 114 and calender roller 115 is illustrated as a single pair of rollers. One of ordinary skill in the art could envision a plurality of rollers 114 and 115. In one embodiment, laminator 104 may include three sets of calendar rollers 115, such as two sets of heated calender rollers 115 and one set of cooled calender rollers 115. As understood by one of ordinary skill in the art, a plurality of calender rollers 115 may be set to different gaps as part of the calendering process. The first set of heated calender rollers 115 may introduce heat and compress the materials being processed. The second set of heated calender rollers 115 may be heated and apply pressure to the materials which form a generally uniform thermoplastic composite liner panel 200. The first set of cooled calender rollers 115 may remove heat from panel 200 and maintain pressure on panel 200.

For one embodiment of a suitable reinforced polymer feedstock 106 known as TWINTEX®, belt rollers 114 are configured to run between approximately one and approximately three meters per minute. Belt rollers 114 are also configured to run at various gaps between approximately one and approximately six millimeters. For another embodiment of a suitable reinforced polymer feedstock 106 known as TRI-PLY® and X-PLY®, belt rollers 114 are configured to run between approximately one and approximately six meters per minute. Belt rollers 114 are also configured to run at various gaps between approximately 0.85 and approximately five millimeters.

As the materials are heated, compressed, and flow within laminator 104 as illustrated by FIG. 2, impression mat 112 imparts its textured surface on to the thermoplastic composite liner panel 200.

In summary, a method of making an embossed liner panel for use as an interior liner of a cargo container includes providing reinforced thermoplastic polymer feedstock 106 and impression mat 112. In one embodiment the method of making an embossed liner panel for use as an interior liner of a cargo container also includes optional release film 110 (FIG. 2). Impression mat 112 includes textured surface 202 (FIG. 3). The method also includes stacking reinforced thermoplastic polymer feedstock 106, and impression mat 112, placing the materials into laminator 104. Laminator 104 heats and compresses the materials. Reinforced polymer feedstock 106 reaches flow and impression mat 112 imparts textured surface 202 to end product thermoplastic composite liner panel 200. As illustrated by FIG. 2, after exiting laminator 104, impression mat 112 may be rolled onto roller 112′ for reuse unmodified by the lamination process.

As illustrated in FIG. 3, thermoplastic composite liner panel 200 includes textured surface 202 which defines impressed areas 204 and raised areas 206. Textured surface 202 is an illustration. One of ordinary skill in the art could envision other textured surfaces, such as patterns and contours. As shown in FIG. 4, impression mat 112 may include nylon filaments 302. In one embodiment, filaments 302 may be randomly oriented. In another embodiment, filaments 302 may be patterned and/or oriented Impression mat 112 may include randomly oriented fused and entangled nylon filaments 302. Filaments 302 may be raised where filaments 302 overlap 306. Filaments 302 may also be oriented into repeating orientations Impression mat 112 may include openings 304 where no filament 302 is present or where a combination of filaments 302 does not overlap.

As shown in FIGS. 3 and 4, filaments 302 may provide textured surface 202 of thermoplastic composite liner panel 200. Filaments 302 may provide embossed or impressed 204 areas of composite liner panel 200 while the absence of filaments 302 allow for raised 206 areas on composite liner panel 200. Furthermore, impression mat 112 may include filaments 302 on the surface of an adjacent coplanar material (not shown) wherein filaments 302 provide raised areas on the coplanar material and the lack of filaments provide embossed or impressed areas on the coplanar material.

In another embodiment, impression mat 112 may include a layer of planar filaments 302 such that both planar surfaces of impression mat 112 provide raised 306 and sunken 304 areas. It should be noted that the above-described materials are used in one embodiment, but that other suitable materials may be used.

Impression mat 112 may be used in conjunction with other processes in order to produce textured thermoplastic composite liner 200. In one embodiment, a textured lamination belt (not shown) may emboss or impress thermoplastic liner panel 200 while thermoplastic liner panel 200 is in a molten or flow state Impression mat 112 as a roller addition to rack 102 may provide embossing or impressing only when applied. Lamination belt 114 may include impression mat 112 or filaments 302 on its surface Impression mat 112 may be included when applied to lamination belt 114. Similarly, impression mat 112 may be included with heated embossing or impressing rolls (not shown) that emboss or impress thermoplastic composite liner panel 200 (FIG. 3) as an additional process Impression mat 112 may be included in the surface of the rolls or may be provided only when desired to the exterior surface of the embossing or impressing rolls. Cost considerations as well as the time and effort required to include or remove impression mat 112 from either lamination belt 114 or rolls are considerations for alternative embossing or impressing processes.

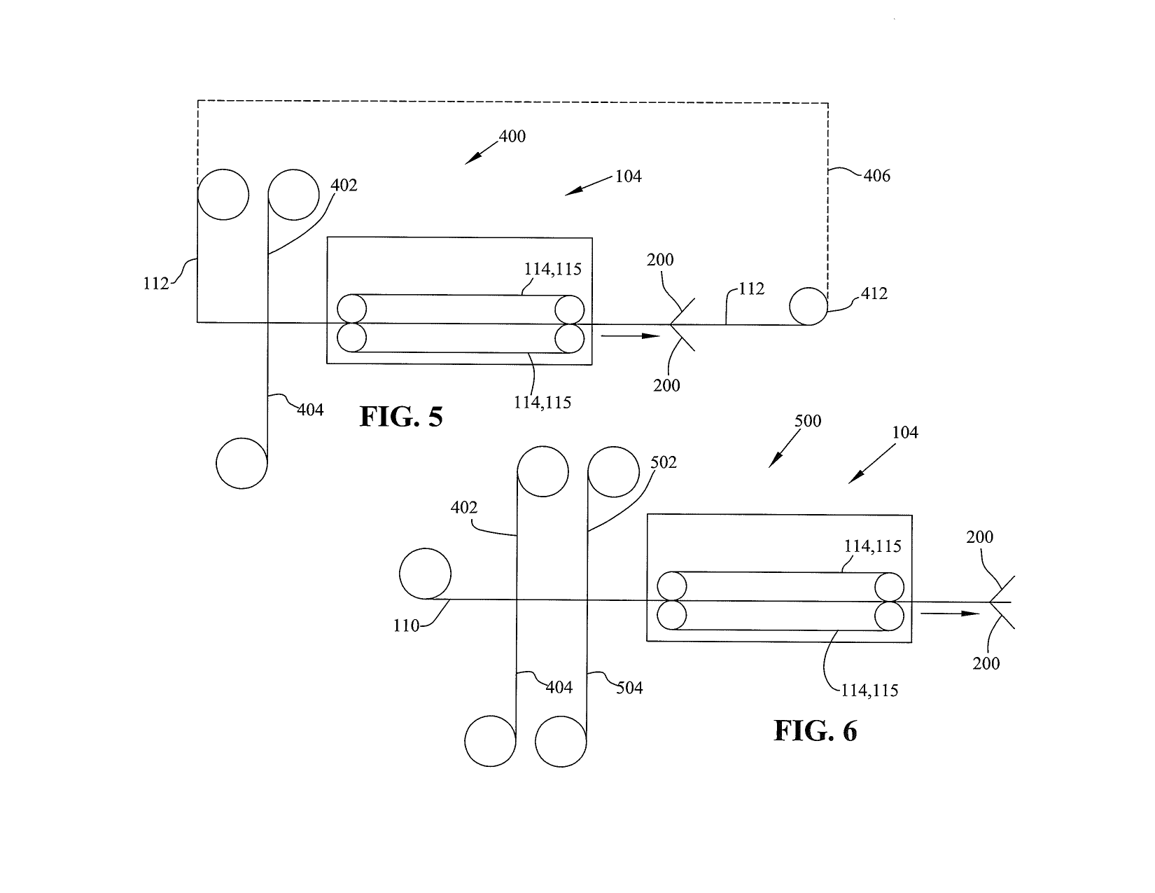

In an alternative embodiment illustrated in FIG. 5, layout 400 includes two groups of materials 402 and 404. Materials 402 and 404 are provided to form two thermoplastic composite liner panels 200. Each group of materials 402 and 404 include a reinforced polymer feedstock 106 (FIG. 2) and may optionally include color layer 108 (FIG. 2), and may optionally include release film 110 (FIG. 2). Both groups of materials 402 and 404 may be fed into laminator 104, such that both sides of impression mat 112 are used to impart textured surface 202 (FIG. 3) onto each of thermoplastic composite liner panels 200. In one embodiment, impression mat 112 is used to simultaneously impart textured surface 202 (FIG. 3) onto each of thermoplastic composite liner panels 200. For example, materials 402 and 404 may be arranged such that impression mat 112 is sandwiched between a first group of materials 402 and a second group of materials 404 as both panels 200 pass through laminator 104. Furthermore, impression mat 112 may be sandwiched between optional release films 110 (not shown). As a result, laminator 104 and its belts 114 and 115 do not impart a textured surface onto thermoplastic composite liner panels 200, but the output production of at least one textured surface 202 for each thermoplastic composite liner panel 200 is doubled as liner panels 200 exit laminator 104 Impression mat 112 may be wound into roller 412 so it can be stored and reused for later embossing or impressing. Also, impression mat 112 may be part of belt mechanism 406 to continually circulate impression mat 112 through the consolidation process.

In another alternative embodiment illustrated in FIG. 6, layout 500 includes two groups of materials 402 and 404. Two groups of materials 402 and 404 (FIG. 5) are provided to form two thermoplastic composite liner panels 200. Both groups of materials 402 and 404 may be fed into laminator 104 along with an optional release film 110, and two impression mats 502 and 504 are used to impart textured surfaces 202 (FIG. 3) onto each of thermoplastic composite liner panels 200. For example, materials 402 and 404 may be arranged such that a first impression mat 502 is adjacent to a first laminator belt 114 and a first calender belt 115 while a second impression mat 504 is adjacent to a second laminator belt 114 and a second calender belt 115. Furthermore, release film 110 may be sandwiched between two groups of materials 402 and 404. As a result, the output production of at least one textured surface 202 for each thermoplastic composite liner panel 200 is doubled as liner panels 200 exit laminator 104.

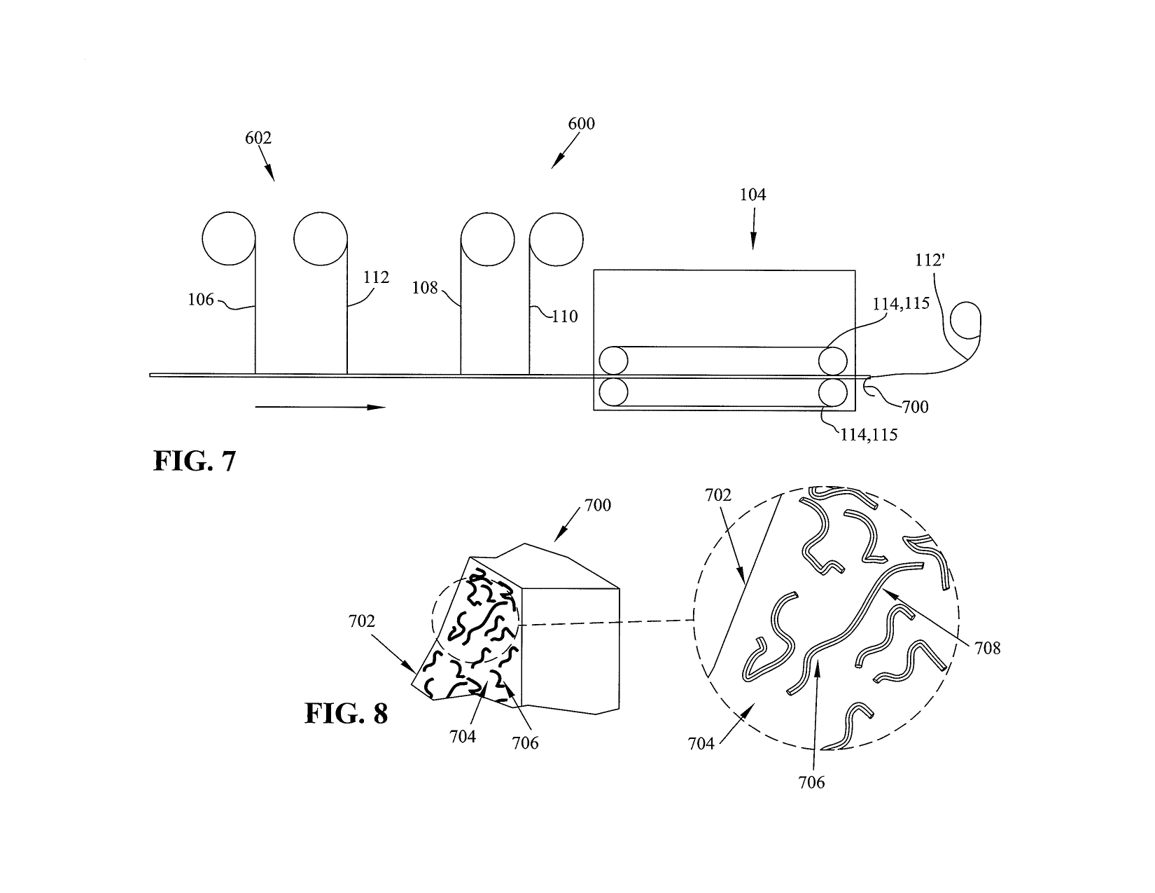

In another alternative embodiment illustrated in FIG. 7, layout 600 includes rack 602 with an alternative arrangement for reinforced polymer feedstock 106, impression mat 112, optional PP color layer 108, and optional PET release film 110. These materials are provided to form thermoplastic composite liner panel 700. In this embodiment, textured impression mat 112 is optionally stacked or layered adjacent to reinforced polymer feedstock 106. Therefore, textured impression mat 112 is optionally incorporated into thermoplastic composite liner panel 700. Mat 112 imparts a textured surface onto liner 700.

As previously described, polypropylene color layer 108 is optional. Color layer 108 may provide a uniform color to finished thermoplastic composite liner panel 700. Color layer 108 may also show parts of textured impression mat 112. As previously described, polyethylene terephthalate release film 110 is optional and provides a release surface between thermoplastic composite liner panel 700 or PP color layer 108 and laminator 104.

Impression mat 112 provides a textured surface for thermoplastic composite liner panel 200. In this embodiment, impression mat 112 is incorporated into thermoplastic composite liner panel 700 to provide an impression to textured surface 702 (FIG. 8).

As illustrated in FIG. 8, thermoplastic composite liner panel 700 includes textured surface 702 which defines areas 704 and raised areas 706. Textured surface 702 is an illustration. One of ordinary skill in the art could envision other textured surfaces, such as patterns and contours. Thermoplastic composite liner panel 700 may also show fibers 708 of impression mat 112. Color of impression mat 112 or the color of fiber 708 may be visible on textured surface 702.

While one or more preferred embodiments of the disclosure have been described above, it should be understood that any and all equivalent realizations of the present disclosure are included within the scope and spirit thereof. The embodiments depicted are presented by way of example only and are not intended as limitations upon the present disclosure. Thus, it should be understood by those of ordinary skill in this art that the present disclosure is not limited to these embodiments since modifications can be made. Therefore it is contemplated that any and all such embodiments are included in the present disclosure as may fall within the literal and equivalent scope of the appended claims

What is claimed is:

1. A method of making an embossed liner panel for use as an interior liner of a cargo carrying vehicle, comprising:
providing a reinforced thermoplastic polymer feedstock;
providing a belt mechanism including an impression mat, the impression mat including a textured surface;
providing a release film between the reinforced polymer feedstock and the impression mat;
stacking the reinforced thermoplastic polymer feedstock, the impression mat and the release film, the release film is provided between the reinforced thermoplastic polymer feedstock and the impression mat;
providing a laminator including at least one roller;
feeding the stacked reinforced polymer feedstock, release film and impression mat into the laminator, the at least one roller of the laminator moving the stacked reinforced polymer feedstock, release film and impression mat through the laminator;
using the laminator to heat and compress the reinforced polymer feedstock and the impression mat to form a thermoplastic composite liner panel and to emboss the textured surface of the impression mat onto the thermoplastic composite liner panel;
releasing the impression mat from the thermoplastic composite liner panel release film such that a thermoplastic composite liner panel is formed from the mated release film and reinforced thermoplastic polymer feedstock; and
continually circulating the impression mat when forming the thermoplastic composite liner panel,
wherein the belt mechanism and the impression mat are separate components from the roller of the laminator.

2. The method of claim 1, wherein the release film and the impression mat are separate components.

3. The method of claim 1, wherein the reinforced polymer feedstock and the release film are mated to each other.

4. The method of claim 1, further comprising:
providing a color layer between the reinforced polymer feedstock and the release film.

5. The method of claim 4 wherein the color layer is made of polypropylene.

6. The method of claim 1, further comprising:
providing a color layer on one of the reinforced thermoplastic polymer feedstock and the impression mat to impart a uniform color to the formed thermoplastic composite liner panel.

7. The method of claim 1, further comprising:
providing a color layer between the reinforced polymer feedstock and the impression mat to impart a uniform color to the formed thermoplastic composite liner panel.

8. The method of claim 1 wherein the impression mat is a nylon matting.

9. The method of claim 1, further comprising:
providing a second reinforced thermoplastic polymer feedstock;
providing a second release film;
stacking second reinforced thermoplastic polymer feedstock and the second release film; and
stacking the impression mat between the release films to impart the textured surface onto the thermoplastic polymer feedstocks to form a pair of thermoplastic composite liner panels.

10. A method of making an embossed liner panel for use as an interior liner of a cargo carrying vehicle, comprising:
providing a reinforced thermoplastic polymer feedstock;
providing an impression mat, the impression mat including a textured surface;
providing a release film between the reinforced polymer feedstock and the impression mat;
stacking the reinforced thermoplastic polymer feedstock, the impression mat and the release film, the release film is provided between the reinforced thermoplastic polymer feedstock and the impression mat;
providing a laminator including at least one roller;
feeding the stacked reinforced polymer feedstock, release film and impression mat into the laminator, the at least one roller of the laminator moving the stacked reinforced polymer feedstock, release film and impression mat through the laminator;
using the laminator to heat and compress the reinforced polymer feedstock and the impression mat to mate the release film onto the reinforced polymer feedstock, thereby forming a thermoplastic composite liner panel, and to emboss the textured surface of the impression mat onto the thermoplastic composite liner panel; and
releasing the impression mat from the release film,
wherein the impression mat is formed by a plurality of randomly oriented filaments so that a random pattern is embossed onto the thermoplastic composite liner panel.

11. The method of claim 10, wherein the release film and the impression mat are separate components.

12. The method of claim 10, further comprising:
collecting the impression mat for reuse.

13. The method of claim 10, further comprising:
providing a belt mechanism for continually circulating the impression mat when embossing the thermoplastic composite liner panel,
wherein the belt mechanism and the impression mat are separate components from the roller of the laminator.

14. The method of claim 10, further comprising:
providing a color layer between the reinforced polymer feedstock and the release film.

15. The method of claim 10, wherein the plurality of randomly oriented filaments further comprises fused and entangled nylon filaments.

16. A method of making an embossed liner panel for use as an interior liner of a cargo carrying vehicle, comprising:
providing a reinforced thermoplastic polymer feedstock;
providing an impression mat, the impression mat including a textured surface;
providing a release film between the reinforced polymer feedstock and the impression mat;
stacking the reinforced thermoplastic polymer feedstock, the impression mat and the release film, the release film is provided between the reinforced thermoplastic polymer feedstock and the impression mat;
providing a laminator including at least one roller;
feeding the stacked reinforced polymer feedstock, release film and impression mat into the laminator, the at least one roller of the laminator moving the stacked reinforced polymer feedstock, release film and impression mat through the laminator;
using the laminator to heat and compress the reinforced polymer feedstock and the impression mat to form a thermoplastic composite liner panel having a top surface and to emboss the textured surface of the impression mat onto a first portion of the top surface of the thermoplastic composite liner panel; and
releasing the impression mat from the release film,
wherein embossed first portion of the top surface is less than the entire top surface of the thermoplastic composite liner panel.

17. The method of claim 16, wherein the top surface of the thermoplastic composite liner panel further comprises a second portion, the second portion being a smooth surface.

18. The method of claim 17, wherein the second portion of the top surface is surrounded by the embossed first portion.

19. The method of claim 17, wherein the second portion of the top surface s disposed along an edge of the thermoplastic composite liner panel.
